(19) United States
(12) Patent Application Publication
(10) Pub. No.: US 2014/0362456 A1
(43) Pub. Date: Dec. 11, 2014

(54) LENS, HYBRID LENS, REPLACEMENT LENS, AND IMAGE PICK-UP DEVICE

(71) Applicant: Panasonic Corporation, Osaka (JP)

(72) Inventor: Nobuyuki KOBAYASHI, Hyogo (JP)

(21) Appl. No.: 14/466,120

(22) Filed: Aug. 22, 2014

Related U.S. Application Data
(63) Continuation of application No. PCT/JP2013/000841, filed on Feb. 15, 2013.

(30) Foreign Application Priority Data
Feb. 24, 2012 (JP) 2012-038463

(51) Int. Cl. G02B 1/04; C08L 33/14; C08L 33/08

(52) U.S. Cl. CPC G02B 1/041; C08L 33/08; C08L 33/14; C08L 2201/10
USPC 359/796; 524/413

(57) ABSTRACT

The present disclosure provides a novel lens including a composite material using a matrix material having predetermined abnormal dispersion. The lens of the present disclosure is a lens including a composite material containing a resin and inorganic fine particles, the resin including a polymeric cured material of an aliphatic compound having a (meth)acryloyl group and represented by the following formula (I) (the symbols in the formula are as defined in the specification):

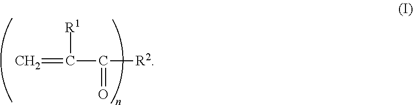

This is a continuation of International Application No. PCT/JP 2013/000841, with an international filing date of Feb. 15, 2013, which claims the foreign priority of Japanese Patent Application No. 2012-038463, filed on Feb. 24, 2012, the entire contents of both of which are hereby incorporated by reference.

### BACKGROUND OF THE INVENTION

1. Field of the Invention

The present disclosure relates to a lens using a composite material in which inorganic fine particles are dispersed in a resin matrix. The present disclosure also relates to a hybrid lens including the lens. The present disclosure also relates to a replacement lens and an image pick-up device each including the lens or the hybrid lens.

2. Description of Related Art

There are known optical materials in which inorganic fine particles are dispersed in a matrix material such as a resin in order to extend the range of optical properties. A material thus composed will be referred to as a composite material hereinafter.

Techniques for achieving predetermined abnormal dispersion using such composite materials are known.

For example, JP 2011-6536 A discloses a material composition containing 1 mass % to 30 mass % of antimony-doped tin oxide particles, 65 mass % or more and less than 98 mass % of an organic compound having one or more polymerizable functional groups per one molecule, and 0.1 mass % to 5 mass % of a polymerization initiator, and also discloses an optical element using the material composition. JP 2011-6536 A discloses a (meth)acrylate compound as the organic compound having one or more polymerizable functional groups per one molecule.

JP 2011-6536 A is directed to providing low abnormal dispersion to a composite material by use of antimony-doped tin oxide particles.

Various optical properties of a composite material can be controlled by selection of the types of the matrix material and the inorganic fine particles or by adjustment of the content of the inorganic fine particles. That is, the optical properties can be controlled by selection of the type of the matrix material.

A wide range of optical properties are required for lenses. Therefore, techniques for controlling the abnormal dispersion of lenses are very useful in optics field, and the development of a lens including a composite material using a matrix material having predetermined abnormal dispersion has been desired.

### SUMMARY OF THE INVENTION

One non-limiting and exemplary embodiment provides a novel lens including a composite material using a matrix material having predetermined abnormal dispersion.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

In one general aspect, the techniques disclosed here feature a lens including a composite material containing a resin and inorganic fine particles. The resin includes a polymeric cured material of an aliphatic compound having a (meth)acryloyl group and represented by the formula (I).

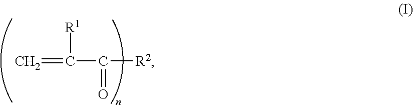

where n is an integer of 2 or more, R¹ represents a hydrogen atom or a methyl group, R² represents an aliphatic group, the number of atoms constituting R² other than hydrogen atom(s) is 4.5 to 18.5 per one (meth)acryloyl group, and R² includes, per one (meth)acryloyl group, at least one group selected from an ethylene oxide group, a propylene oxide group, and an isopropylene oxide group.

With the above features, a novel lens using a matrix material having predetermined abnormal dispersion can be obtained.

These general and specific aspects may be implemented using a system, a method, a computer program, and any combination of systems, methods, and computer programs.

### BRIEF DESCRIPTION OF DRAWINGS

FIG. 1 is a schematic cross-sectional view showing a lens of a first embodiment.

FIG. 2 is a partially enlarged view of a cross-section of the lens of the first embodiment.

FIG. 3 is a schematic cross-sectional view showing a hybrid lens of a second embodiment.

FIG. 4 is a schematic diagram showing a production process of the hybrid lens of the second embodiment.

FIG. 5 is a schematic diagram showing a replacement lens of a third embodiment and an image pick-up device of a fourth embodiment.

### DETAILED DESCRIPTION

The first embodiment of the present disclosure provides a lens including a composite material containing a resin and inorganic fine particles,

the resin including a polymeric cured material of an aliphatic compound having a (meth)acryloyl group and represented by the formula (I).

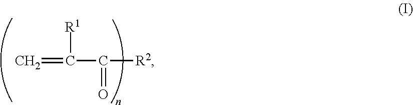

where n is an integer of 2 or more, R¹ represents a hydrogen atom or a methyl group, R² represents an aliphatic group, the number of atoms constituting R² other than hydrogen atom(s) is 4.5 to 18.5 per one (meth)acryloyl group, and R² includes, per one (meth)acryloyl group, at least one group selected from an ethylene oxide group, a propylene oxide group, and an isopropylene oxide group.

The second embodiment of the present disclosure provides the lens as set forth in the first embodiment, wherein a ΔP_{g, F} representing abnormal dispersion of the resin is less than 0.03.

The third embodiment of the present disclosure provides the lens as set forth in the first or second embodiment, wherein the aliphatic compound is at least one compound selected from the group consisting of compounds represented by any of the following formulae (II), (III), and (IV):

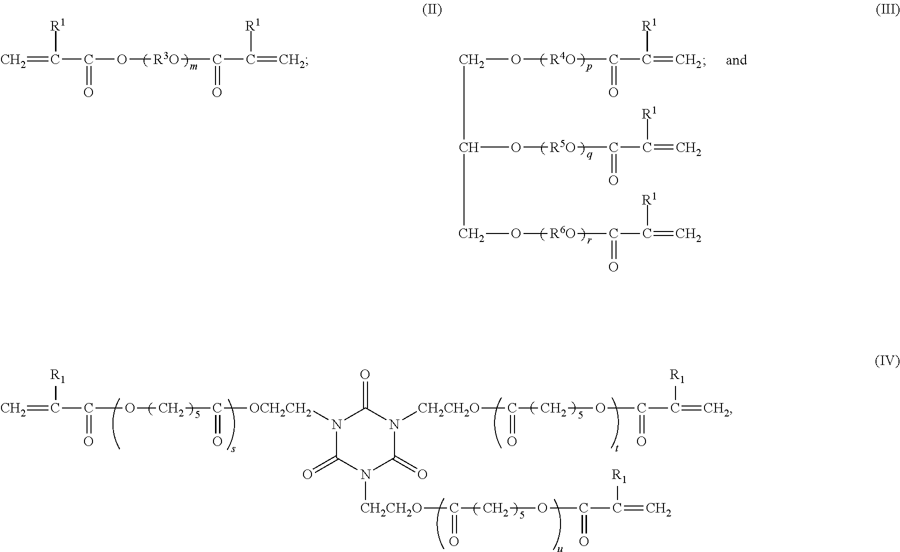

where R¹ represents a hydrogen atom or a methyl group, R³, R⁴, R⁵, and R⁶ each independently represent —CH₂CH₂—, —CH₂CH₂CH₂—, —CH₂CH(CH₃)—, or —CH(CH₃)CH₂—, and m, p, q, r, s, t, and u are each independently an integer.

The fourth embodiment of the present disclosure provides the lens as set forth in any one of the first to third embodiments, wherein when a refractive index and an Abbe number of the resin are respectively denoted by nd and vd, 1.45<nd<1.55 and 45<vd<55 are satisfied.

The fifth embodiment of the present disclosure provides the lens as set forth in any one of the first to fourth embodiments, wherein the polymeric cured material is a material cured by using a hydroxyketone compound having a molecular weight of 150 or more and 2000 or less as a polymerization initiator.

The sixth embodiment of the present disclosure provides a hybrid lens including:

a first lens serving as a base; and

a second lens stacked on the first lens and containing a resin,

the second lens being the lens of any one of the first to fifth embodiments.

The seventh embodiment of the present disclosure provides a replacement lens attachable to and detachable from an image pick-up device, the replacement lens including the lens of any one of the first to fifth embodiments.

The eight embodiment of the present disclosure provides a replacement lens attachable to and detachable from an image pick-up device, the replacement lens including the hybrid lens of the sixth embodiment.

The ninth embodiment of the present disclosure provides an image pick-up device including the lens of any one of the first to fifth embodiments.

The tenth embodiment of the present disclosure provides an image pick-up device including the hybrid lens of the sixth embodiment.

Hereinafter, the techniques of the present disclosure will be described in detail with reference to specific embodiments. However, the inventions of the present disclosure are not limited to these embodiments and can be modified as appropriate within the technical scope of the present disclosure.

### First Embodiment

Hereinafter, a lens 1 of a first embodiment will be described with reference to the drawings.

[1. Lens]

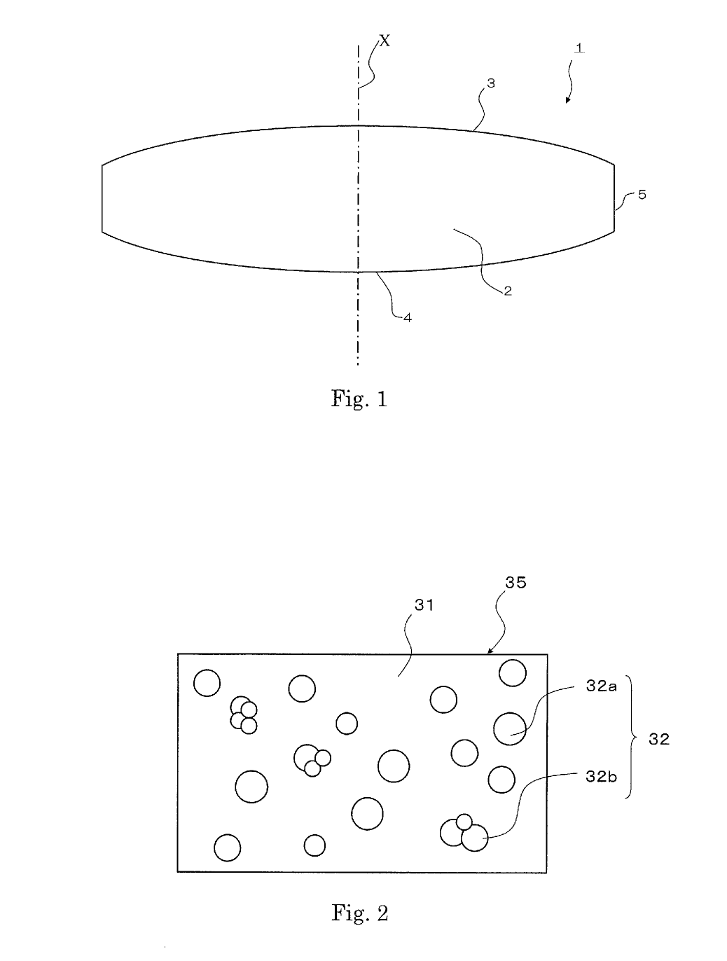

FIG. 1 is a schematic cross-sectional view of the lens 1 having refractive-index distribution according to the present embodiment. The lens 1 is a disc-shaped member constituted by an optical portion 2. The lens 1 is a biconvex lens.

The lens 1 includes a first optical surface 3, a second optical surface 4, and an outer circumferential surface 5. The first optical surface 3 and the second optical surface 4 are opposed to each other in the direction of an optical axis X.

The outer circumferential surface 5 is a surface connecting the edges of the first optical surface 3 to the edges of the second optical surface 4. The outer circumferential surface 5 is the side surface of the lens 1.

The outer diameter of the lens 1 is defined by the outer circumferential surface 5. In the present embodiment, the outer diameter is, for example, 10 mm to 100 mm.

[2. Composite Material]

FIG. 2 is a partially enlarged cross-sectional view for illustrating the lens 1.

As shown in FIG. 2, the lens 1 is formed of a composite material 35. The composite material 35 is composed of a resin 31 as a matrix material and inorganic fine particles 32.

In the present embodiment, the inorganic fine particles 32 used are those having a higher refractive index than the resin. By adjusting the material, particle diameter, and number of the inorganic fine particles, it is possible to adjust the refractive index of the composite material in which the inorganic fine particles are dispersed in the resin.

The inorganic fine particles 32 may be either aggregated particles or non-aggregated particles, and generally include primary particles 32a and secondary particles 32b each of which is formed by aggregation of a plurality of the primary particles 32a. The dispersion state of the inorganic fine particles 32 is not particularly limited, since the intended effect can be obtained as long as the inorganic fine particles are present in the matrix material. Desirably, the inorganic fine particles 32 are uniformly dispersed in the resin 31. The state where “the inorganic fine particles 32 are uniformly dispersed in the resin 31” means a state where the primary particles 32a and the secondary particles 32b of the inorganic fine particles 32 are dispersed substantially uniformly without being locally present in a specific region of the composite material 35. In order to control the light transmittance as an optical material, it is desirable that the particles have good dispersibility. Therefore, it is desirable that the inorganic fine particles 32 consist of only the primary particles 32a.

The particle diameter of the inorganic fine particles 32 is a factor in ensuring the light transmittance of the composite material 35 in which the inorganic fine particles 32 are dispersed. When the particle diameter of the inorganic fine particles 32 is sufficiently smaller than the wavelength of light, the composite material 35 in which the inorganic fine particles 32 are dispersed can be regarded as a homogeneous medium free from unevenness of refractive index. Therefore, it is desirable that the maximum particle diameter of the inorganic fine particles 32 be equal to or smaller than the wavelength of visible light. For example, since visible light has a wavelength ranging from 400 nm to 700 nm, it is desirable that the maximum particle diameter of the inorganic fine particles 32 be 400 nm or less. The maximum particle diameter of the inorganic fine particles 32 can be determined, for example, by taking a scanning electron microscope (SEM) photograph of the inorganic fine particles 32 and measuring the particle diameter of the largest inorganic fine particle 32 (the secondary particle diameter when the largest inorganic fine particle is a secondary particle).

When the particle diameter of the inorganic fine particles 32 is larger than ¼ of the wavelength of light, the light transmittance could be decreased due to Rayleigh scattering. Therefore, in order to achieve high transmittance in the visible light region, it is desirable that the median particle diameter (median diameter d50) of the inorganic fine particles 32 be 100 nm or less. However, when the inorganic fine particles have a particle diameter smaller than 1 nm, the inorganic fine particles may emit fluorescence if made of a material that exhibits a quantum effect, which may affect the characteristics of an optical portion formed by use of the composite material 35. In view of the above, the median particle diameter of the inorganic fine particles is desirably in the range of 1 nm to 100 nm, and more desirably in the range of 1 nm to 50 nm. In particular, the median particle diameter of the inorganic fine particles 32 is even more desirably 20 nm or less, because in this case the influence of Rayleigh scattering is considerably reduced, and the light transmittance of the composite material 35 is particularly increased. The median particle diameter of the inorganic fine particles 32 can be determined, for example, by taking a SEM photograph of the inorganic fine particles and measuring the particle diameters of 200 or more of the inorganic fine particles (the secondary particle diameters when the particles are secondary particles).

[3. Inorganic Fine Particle]

Examples of the material of the inorganic fine particles 32 include oxides and fluorides of metal elements. Examples of the oxides of metal elements include silicon oxide, zirconium oxide, titanium oxide, zinc oxide, aluminum oxide, yttrium oxide, barium titanate, europium oxide, magnesium oxide, niobium oxide, tantalum oxide, tungsten oxide, hafnium oxide, indium oxide, indium phosphate, tin oxide, indium tin oxide, cerium oxide, barium sulfate, gadolinium oxide, and lanthanum oxide. The silicon oxide includes those in which voids are formed, such as porous silica. Examples of the fluorides include magnesium fluoride, cerium fluoride, lanthanum fluoride, niobium fluoride, and yttrium fluoride. As a matter of course, the material of the inorganic fine particles 32 is not limited to those mentioned above.

The refractive index of the inorganic fine particles 32 varies from material to material. Therefore, depending on their material, the inorganic fine particles 32 could have a higher refractive index or a lower refractive index than the resin 31. The material used may be selected as appropriate depending on the optical properties required for the lens 1.

[4. Resin Material]

In the present embodiment, the resin serving as a matrix material includes a cured material obtained by polymerization of an aliphatic monomer (referred to as an aliphatic compound (I) hereinafter) having a (meth)acryloyl group and represented by the formula (I).

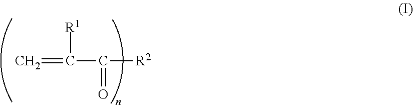

In the above formula, n is an integer of 2 or more and desirably 2 or 3, R¹ represents a hydrogen atom or a methyl group, R² represents an aliphatic group, the number of atoms constituting R² other than hydrogen atom(s) is 4.5 to 18.5 per one (meth)acryloyl group, and R² includes, per one (meth)acryloyl group, at least one group selected from an ethylene oxide group, a propylene oxide group, and an isopropylene oxide group. The plurality of R¹ may be the same as or different from each other. R² includes at least a carbon atom, an oxygen atom, and a hydrogen atom, and may include another atom (e.g., a nitrogen atom). It is desirable that R² be bonded to the (meth)acryloyl group via an oxygen atom.

By virtue of including a polymer of the aliphatic compound (I), the resin can exhibit negative abnormal dispersion or small positive abnormal dispersion. Here, the abnormal dispersion is represented by ΔP_{g, F} which is a deviation of a partial dispersion ratio P_{g, F} of a material from that point on a standard line of normal dispersion glass which corresponds to the Abbe number vd of the material. The partial dispersion ratio P_{g, F} is a value defined by the mathematical formula (1) given below. In the mathematical formula (1), ng, nF, and nC represent refractive indices for g-ray (wavelength: 435.8 nm), F-ray (wavelength: 486 nm), and C-ray (wavelength: 656 nm), respectively.

P_{g,F}=(ng−nF)/(nF−nC) (1)

In the present embodiment, the resin can have a ΔP_{g, F} value that is less than 0.03. In general, a resin resulting from polymerization and curing of a (meth)acrylate compound has a ΔP_{g, F} of 0.03 or more as shown in comparative examples described later. That is, the resin in the present embodiment exhibits negative abnormal dispersion or smaller positive abnormal dispersion than that in conventional (meth)acrylate resins and, therefore, the combined use of the resin with inorganic fine particles allows for a wider range of abnormal dispersion of lenses. In particular, the resin resulting from polymerization and curing of the aliphatic compound (I) is more advantageous than conventional (meth)acrylate resins for obtaining a lens having large negative abnormal dispersion.

The possible reasons why the resin used in the present embodiment can achieve a ΔP_{g, F} less than 0.03 are that the resin does not have an aromatic structure having a high refractive index, and that the resin includes a plurality of ethylene oxide groups, propylene oxide groups, and/or isopropylene oxide groups (the number of the groups is one or more per one (meth)acryloyl group). When the molecular chain other than the (meth)acryloyl groups in the aliphatic compound (I) is too short or too long, light scattering is likely to occur, and the light transmittance is undesirably reduced. Therefore, the number of atoms constituting R² other than hydrogen atoms is 4.5 to 18.5 per one (meth)acryloyl group.

Desirable examples of the aliphatic compound (I) include compounds represented by the formula (II), compounds represented by the formula (III), and compounds represented by the formula (IV). These compounds can be used alone, or two or more thereof can be used in combination.

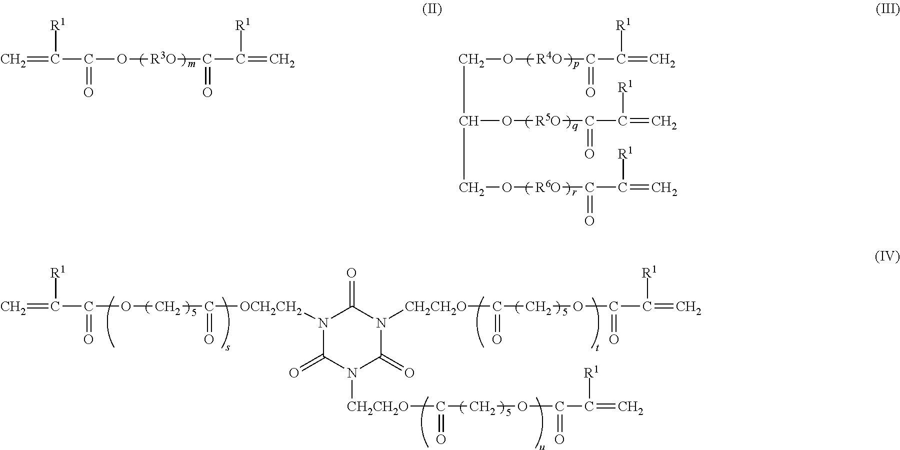

In the above formulae, R¹ is the same as described above for the formula (I), and R³, R⁴, R⁵, and R⁶ each independently represent —CH₂CH₂—, —CH₂CH₂CH₂—, —CH₂CH(CH₃)—, or —CH(CH₃)CH₂—. In addition, m, p, q, r, s, t, and u are each independently an integer, typically a natural number, and are selected so that the number of atoms constituting R² other than hydrogen atom(s) is 4.5 to 18.5 per one (meth)acryloyl group.

R³, R⁴, R⁵, and R⁶ may each include two or more groups selected from —CH₂CH₂—, —CH₂CH₂CH₂—, —CH₂CH(CH₃)—, and —CH(CH₃)CH₂—, and the sequence of these groups may be arbitrary.

Specific examples of the above compounds are as follows. The compounds represented by the formula (II) include: compounds in which R¹ is a hydrogen atom, R³ is —CH₂CH₂—, and m is 3 to 12; and compounds in which R¹ is a hydrogen atom, R³ is —CH₂CH(CH₃)— or —CH(CH₃)CH₂—, and m is 2 to 9. The compounds represented by the formula (III) include compounds in which R¹ is a hydrogen atom, R⁴, R⁵, and R⁶ are each —CH₂CH₂—, and p+q+r is 3 to 15. The compounds represented by the formula (IV) include compounds in which R¹ is a hydrogen atom, and s+t+u is 0 to 3 or particularly 0 to 1.

With the resin of the present embodiment, it is also possible to obtain optical properties in which the refractive index nd and the Abbe number vd of the resin satisfy 1.45<nd<1.55 and 45<vd<55.

The resin may include an additive such as an antioxidant, an ultraviolet absorber, a mold release agent, a conductive agent, an antistatic agent, a surfactant, or a thermally-stabilizing agent, as long as at least one of the effects of the present disclosure can be obtained.

A polymerization initiator used for curing of the aliphatic compound (I) may remain in the resin.

[5. Production Method]

For example, the lens 1 can be produced as follows: a mixture is prepared by dispersing inorganic fine particles in the aliphatic compound (I); the mixture is filled into a lens mold having a shape corresponding to the lens; and the aliphatic compound is cured through its polymerization.

The method for the polymerization and curing is not particularly limited. Either thermal curing polymerization or energy-ray curing polymerization may be employed.

In order to facilitate the polymerization and curing, it is desirable that the mixture include a polymerization initiator.

Specifically, for example, the lens 1 can be produced by a method including: preparing a homogeneous mixture of the aliphatic compound (I), an energy-ray polymerization initiator, and inorganic fine particles; filling the mixture into a transparent lens mold made of glass; and polymerizing and curing the aliphatic compound (I) by irradiation with energy rays (e.g., ultraviolet rays). A hydroxyketone compound having a molecular weight of 150 or more and 2000 or less is suitable as the energy-ray polymerization initiator.

### Second Embodiment

Next, a hybrid lens 40 according to a second embodiment will be described using the drawings.

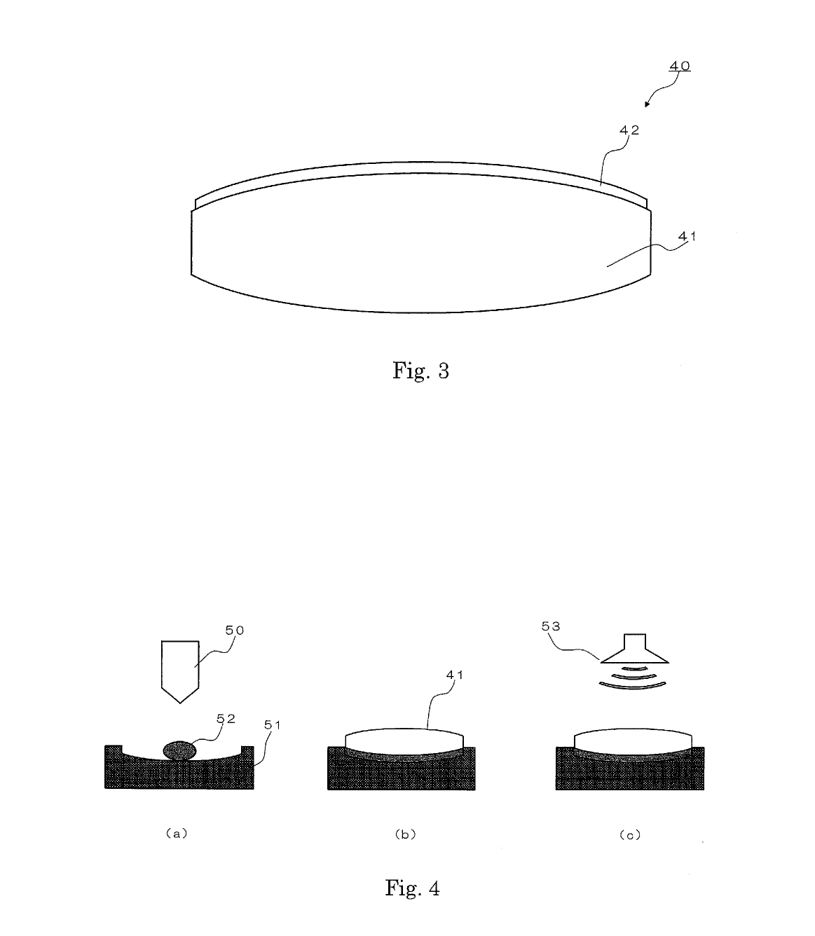

FIG. 3 is a schematic cross-sectional view showing the hybrid lens 40. The hybrid lens 40 includes: a first lens 41 made of a glass material and serving as a base; and a second lens 42 made of the composite material 35. The second lens 42 is stacked on an optical surface of the first lens 41.

The lens 1 described in the first embodiment is used as the second lens 42 (it should be noted that one optical surface of the second lens 42 in FIG. 3 has a concave shape).

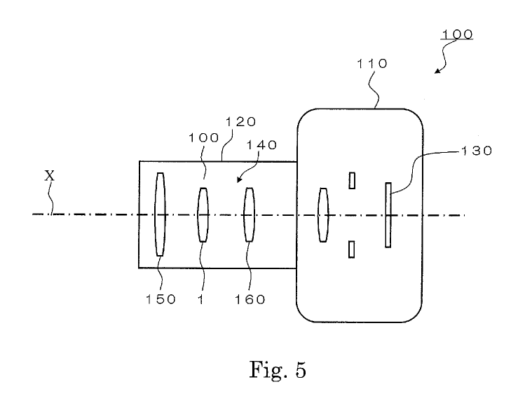

Next, a production method of the hybrid lens 40 will be described using FIG. 4. In FIG. 4, the resin included in the composite material 35 is an ultraviolet-cured polymer of the aliphatic compound (I).

FIG. 4 is a schematic diagram showing a production process of the hybrid lens 40.

First, the first lens 41 is molded. The first lens 41 is molded using a commonly-known production method such as lens polishing, injection molding, or press molding.

Next, as shown in FIG. 4(a), a mixture 52 (a raw material of the composite material 35) prepared by homogeneously mixing the aliphatic compound (I), an energy-ray polymerization initiator, and inorganic fine particles is discharged onto a mold surface of a mold 51 using a dispenser 50.

Next, as shown in FIG. 4(b), the first lens 41 is placed onto the mixture 52 so that the mixture 52 is pressed and extended to a predetermined thickness.

Then, as shown in FIG. 4(c), energy rays (e.g., ultraviolet rays) are applied toward the top of the first lens 41 from a light source 53 to cure the mixture 52 and thus to form the second lens 42.

### Third and Fourth Embodiments

Next, a replacement lens 120 according to a third embodiment and an image pick-up device (camera 100) according to a fourth embodiment will be described together with reference to the drawings. FIG. 5 shows a schematic diagram of the camera 100.

The camera 100 includes a camera body 110 and the replacement lens 120 attached to the camera body 110. The camera 100 is one example of the image pick-up device.

The camera body 110 has an image pick-up element 130.

The replacement lens 120 is configured to be replaceable, that is, to be attachable to and detachable from the camera body 110. The replacement lens 120 is, for example, a telephoto zoom lens. The replacement lens 120 has an imaging optical system 140 for focusing light flux on the image pick-up element 130 of the camera body 120. The imaging optical system 140 is composed of the above lens 1 and refractive lenses 150 and 160.

In another example of the replacement lens 120 and the camera 100, the hybrid lens 40 can be used in place of the lens 1.

In another example of the camera 100, the camera can be configured to have a camera body portion and a lens portion configured to be inseparable from the camera body portion, the lens portion including the lens 1 and/or the hybrid lens 40.

### EXAMPLES

Hereinafter, the techniques of the present disclosure will be described in detail with reference to examples and comparative examples. However, the techniques of the present disclosure are not limited to the examples. Table 1 collectively shows the details of the examples and the comparative examples.

TABLE 1

| | Number of | Number of | Polymerization | Refractive | Abbe | |
|---|---|---|---|---|---|---|
| | groups* | atoms** | initiator | index nd | number | ΔP_{g,F} |
| Example 1 | 3.5 | 14.5 | Irgacure 184 | 1.47709 | 52.5 | −0.0418 |
| Example 2 | 3 | 11 | Irgacure 184 | 1.50267 | 51.3 | −0.035 |
| Example 3 | 1 | 4.5 | Irgacure 184 | 1.47700 | 52.3 | +0.0244 |
| Example 4 | 6 | 18.5 | Irgacure 184 | 1.48774 | 56.2 | +0.023 |
| Example 5 | 1.33 | 8.66 | Irgacure 184 | 1.5129 | 53.4 | −0.0028 |
| Example 6 | 3.5 | 14.5 | ESACURE KIP150 | 1.47755 | 52.0 | −0.0405 |
| Comparative | 6 | 24.5 | Irgacure 184 | 1.46879 | 56.2 | +0.0772 |
| Example 1 | | | | | | |
| Comparative | 1.5 | 13 | Irgacure 184 | 1.5732 | 30.2 | +0.0635 |
| Example 2 | | | | | | |
| Comparative | 0 | 5.5 | Irgacure 184 | 1.501 | 55.0 | +0.0502 |
| Example 3 | | | | | | |
| Comparative | 0 | 7 | Irgacure 184 | 1.53464 | 51.7 | +0.03 |
| Example 4 | | | | | | |

*The number, per one acryloyl group, of ethylene oxide groups, propylene oxide groups, and isopropylene oxide groups present between acryloyl groups.
**The number, per one acryloyl group, of atoms other than hydrogen atoms present between acryloyl groups.

### Example 1

A resin A composed of 97 wt % of an aliphatic acrylate represented by the chemical formula (1) and 3 wt % of a polymerization initiator (Irgacure184 manufactured by BASF; 1-Hydroxycyclohexyl phenyl ketone having a molecular weight of 204) was irradiated with ultraviolet rays (80 mw/cm²·90 sec) using a UV irradiation apparatus (SP-9 manufactured by USHIO INC.), and thus a 100 μm-thick measurement sample for evaluation of optical properties was fabricated. The optical properties (refractive index, Abbe number, and ΔP_{g, F}) of the obtained measurement sample were measured using a prism coupler (MODEL 2010 manufactured by Metricon Corporation). The results are shown in Table 1. It can be understood from Table 1 that a resin material showing negative abnormal dispersion was obtained.

In addition, 20 wt % of ZrO₂ fine particles (having a diameter of 10 nm) were added to the resin A to fabricate a composite material. The ΔP_{g, F} was measured in the same manner as above. The ΔP_{g, F} was −0.045, which confirmed that the composite material can be used in a lens.

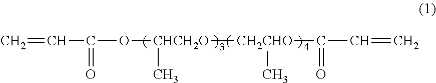

### Example 2

A resin B composed of 97 wt % of an aliphatic acrylate represented by the chemical formula (2) and 3 wt % of a polymerization initiator (Irgacure184 manufactured by BASF) was fabricated, and the optical properties of the measurement sample obtained by irradiating the resin B with ultraviolet rays as in Example 1 were evaluated in the same manner as in Example 1. The results are shown in Table 1. It can be understood from Table 1 that a resin material showing negative abnormal dispersion was obtained. Therefore, it can be understood that a lens including a composite material whose matrix material shows negative abnormal dispersion can be fabricated using the resin B.

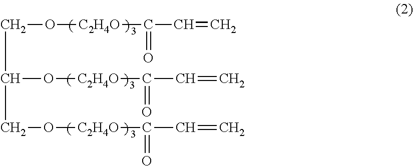

### Example 3

A resin C composed of 97 wt % of an aliphatic acrylate represented by the chemical formula (3) and 3 wt % of a polymerization initiator (Irgacure184 manufactured by BASF) was fabricated, and the optical properties of the measurement sample obtained by irradiating the resin C with ultraviolet rays as in Example 1 were evaluated in the same manner as in Example 1. The results are shown in Table 1. It can be understood from Table 1 that a resin material showing small positive abnormal dispersion (ΔP_{g, F}<0.03) was obtained. Therefore, it can be understood that a lens including a composite material whose matrix material shows small positive abnormal dispersion can be fabricated using the resin C.

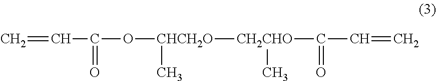

### Example 4

A resin D composed of 97 wt % of an aliphatic acrylate represented by the chemical formula (4) and 3 wt % of a polymerization initiator (Irgacure184 manufactured by BASF) was fabricated, and the optical properties of the measurement sample obtained by irradiating the resin D with ultraviolet rays as in Example 1 were evaluated in the same manner as in Example 1. The results are shown in Table 1. It can be understood from Table 1 that a resin material showing small positive abnormal dispersion (ΔP_{g, F}<0.03) was obtained.

In addition, 20 wt % of ZrO₂ fine particles (having a diameter of 10 nm) were added to the resin D to fabricate a composite material. The ΔP_{g, F} of the composite material was measured in the same manner as above. The ΔP_{g, F} was 0.015, which confirmed that the composite material can be used in a lens.

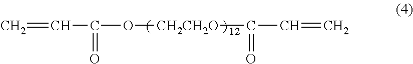

### Example 5

A resin E composed of 97 wt % of an aliphatic acrylate represented by the chemical formula (5) and 3 wt % of a polymerization initiator (Irgacure184 manufactured by BASF) was fabricated, and the optical properties of the measurement sample obtained by irradiating the resin E with ultraviolet rays as in Example 1 were evaluated in the same manner as in Example 1. The results are shown in Table 1. It can be understood from Table 1 that a resin material showing negative abnormal dispersion was obtained. Therefore, it can be understood that a lens including a composite material whose matrix material shows negative abnormal dispersion can be fabricated using the resin E.

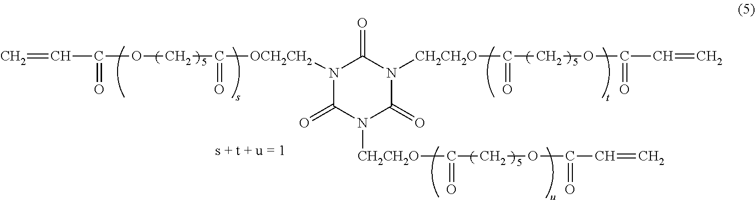

### Example 6

A resin F was fabricated and a measurement sample was obtained from the resin F in the same manner as in Example 1, except that a polymerization initiator (ESACURE KIP150 manufactured by Lamberti; Oligo[2-hydroxy-2-methyl-1-[4-(1-methylvinyl)phenyl]propanone] having a (weight-average) molecular weight of 550) was used instead of the polymerization initiator (Irgacure184 manufactured by BASF) used in Example 1. The optical properties of the measurement sample were evaluated in the same manner as in Example 1. The results are shown in Table 1. It can be understood from Table 1 that a resin material showing negative abnormal dispersion was obtained. Therefore, it can be understood that a lens including a composite material whose matrix material shows negative abnormal dispersion can be fabricated using the resin F.

### Comparative Example 1

A resin G composed of 97 wt % of an aliphatic acrylate represented by the chemical formula (6) and 3 wt % of a polymerization initiator (Irgacure184 manufactured by BASF) was fabricated, and the optical properties of the measurement sample obtained by irradiating the resin G with ultraviolet rays as in Example 1 were evaluated in the same manner as in Example 1. The results are shown in Table 1. It can be understood from Table 1 that the ΔP_{g, F} representing the abnormal dispersion of the resin has a large positive value (ΔP_{g, F}≧0.03) when the number, per one acryloyl group, of atoms other than hydrogen atoms present in the groups positioned between acryloyl groups is too large.

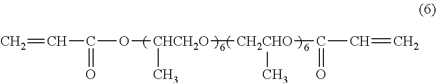

### Comparative Example 2

A resin H composed of 97 wt % of an aromatic acrylate represented by the chemical formula (7) and 3 wt % of a polymerization initiator (Irgacure184 manufactured by BASF) was fabricated, and the optical properties of the measurement sample obtained by irradiating the resin H with ultraviolet rays as in Example 1 were evaluated in the same manner as in Example 1. The results are shown in Table 1. It can be understood from Table 1 that the ΔP_{g, F} representing the abnormal dispersion of the resin has a large positive value (ΔP_{g, F}≧0.03) when an aromatic acrylate is used.

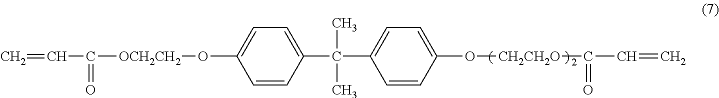

### Comparative Example 3

A resin I composed of 97 wt % of an aliphatic acrylate represented by the chemical formula (8) and 3 wt % of a polymerization initiator (Irgacure184 manufactured by BASF) was fabricated, and the optical properties of the measurement sample obtained by irradiating the resin I with ultraviolet rays as in Example 1 were evaluated in the same manner as in Example 1. The results are shown in Table 1. It can be understood from Table 1 that the ΔP_{g, F} representing the abnormal dispersion of the resin has a large positive value (ΔP_{g, F}≧0.03) in the case of an aliphatic acrylate that do not have any of ethylene oxide groups, propylene oxide groups, and isopropylene oxide groups.

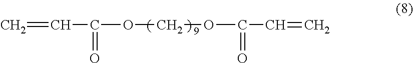

### Comparative Example 4

A resin J composed of 97 wt % of an aliphatic acrylate represented by the chemical formula (9) and 3 wt % of a polymerization initiator (Irgacure184 manufactured by BASF) was fabricated, and the optical properties of the measurement sample obtained by irradiating the resin J with ultraviolet rays as in Example 1 were evaluated in the same manner as in Example 1. The results are shown in Table 1. It can be understood from Table 1 that the ΔP_{g, F} representing the abnormal dispersion of the resin has a large positive value (ΔP_{g, F}≧0.03) in the case of an aliphatic acrylate that do not have any of ethylene oxide groups, propylene oxide groups, and isopropylene oxide groups.

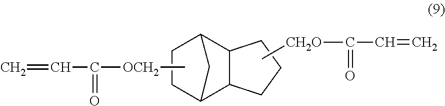

### INDUSTRIAL APPLICABILITY

The lens and the hybrid lens of the present disclosure can be suitably used in an image pick-up device, a replacement lens of an image pick-up device, a DVD optical system, etc.

What is claimed is:

1. A lens comprising a composite material containing a resin and inorganic fine particles,
wherein the resin comprises a polymeric cured material of an aliphatic compound having a (meth)acryloyl group and represented by the following formula (I): 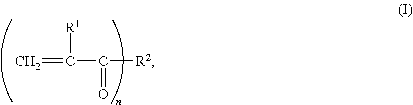
where n is an integer of 2 or more, R¹ represents a hydrogen atom or a methyl group, R² represents an aliphatic group, the number of atoms constituting R² other than hydrogen atom(s) is 4.5 to 18.5 per one (meth)acryloyl group, and R² includes, per one (meth)acryloyl group, at least one group selected from an ethylene oxide group, a propylene oxide group, and an isopropylene oxide group.

2. The lens according to claim 1, wherein a ΔP_{g, F} representing abnormal dispersion of the resin is less than 0.03.

3. The lens according to claim 1, wherein the aliphatic compound is at least one compound selected from the group consisting of compounds represented by any of the following formulae (II), (III), and (IV): 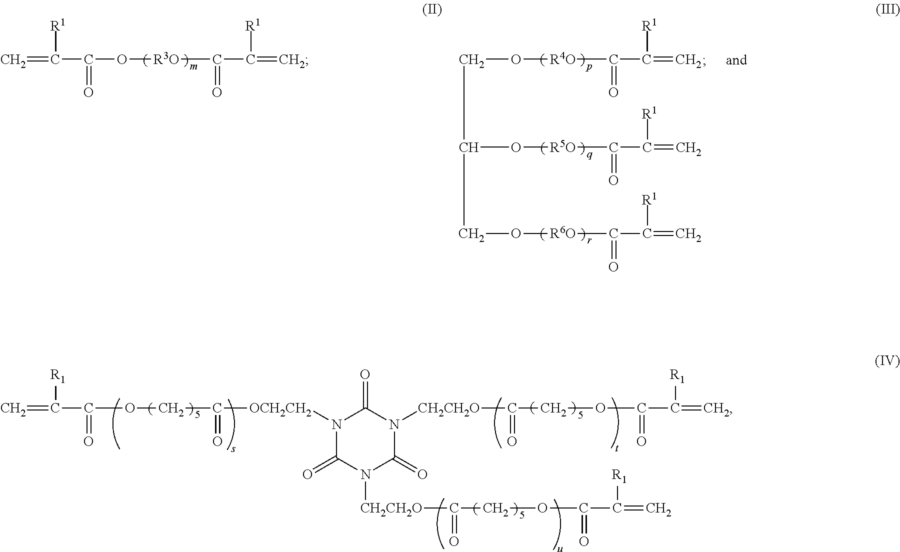
where R¹ represents a hydrogen atom or a methyl group, R³, R⁴, R⁵, and R⁶ each independently represent —CH₂CH₂—, —CH₂CH₂CH₂—, —CH₂CH(CH₃)—, or —CH(CH₃)CH₂—, and m, p, q, r, s, t, and u are each independently an integer.

4. The lens according to claim 1, wherein when a refractive index and an Abbe number of the resin are respectively denoted by nd and vd, 1.45<nd<1.55 and 45<vd<55 are satisfied.

5. The lens according to claim 1, wherein the polymeric cured material is a material cured by using a hydroxyketone compound having a molecular weight of 150 or more and 2000 or less as a polymerization initiator.

6. A hybrid lens comprising:
a first lens serving as a base; and
a second lens stacked on the first lens and containing a resin,
wherein the second lens is the lens according to claim 1.

7. A replacement lens attachable to and detachable from an image pick-up device, the replacement lens comprising the lens according to claim 1.

8. A replacement lens attachable to and detachable from an image pick-up device, the replacement lens comprising the hybrid lens according to claim 6.

9. An image pick-up device comprising the lens according to claim 1.

10. An image pick-up device comprising the hybrid lens according to claim 6.
